(19) United States
(12) Patent Application Publication
(10) Pub. No.: US 2004/0151353 A1
(43) Pub. Date: Aug. 5, 2004

(54) Identification system

(76) Inventor: Catherine Topping, Worcester (GB)

Correspondence Address: JOSEPH J. JOCHMAN, ANDRUS, SCEALES, STARKE & SAWALL, LLP, Suite 1100, 100 East Wisconsin Avenue, Milwaukee, WI, 53202-4178, US

(21) Appl. No.: 10/720,741

(22) Filed: Nov. 24, 2003

Related U.S. Application Data
(63) Continuation-in-part of application No. 09/558,828, filed on Apr. 26, 2000, now Pat. No. 6,654,484.

(30) Foreign Application Priority Data
Oct. 28, 1999 (GB) 9925587.9
Dec. 17, 1999 (GB) 9929757.4

(51) Int. Cl. G06K 9/00

(52) U.S. Cl. 382/124

(57) ABSTRACT

An identification system for use in controlling the operation of a device comprises comparing fingerprint data with stored data to identify both an individual and which of the individual's fingerprints has been input, and using the identity of the individual and the finger in controlling the operation of the device.

This application is a Continuation-in-Part of U.S. patent application Ser. No. 09/558828 filed Apr. 26th 2000, now U.S. Pat. No. 6,654,484.

The invention relates to an identification system for use in identifying an individual.

It is well known to use fingerprint pattern recognition in the identification of people. For example fingerprint pattern records have been used by the police around the world to identify individuals. It is also known to use electronic fingerprint pattern recognition systems to control access rights in computer systems, the computer holding a database of fingerprint patterns of authorised users and only permitting use of the computer or certain operations of the computer by individuals whose fingerprint pattern match one of the fingerprint patterns stored in the database. Typically, only one fingerprint pattern of each authorised user is stored.

In order to achieve an increased level of security, it is known, for example from U.S. Pat. No. 6,393,139, to require a user of a computer system to enter two or more of his fingerprint patterns, in a pre-determined order or sequence, before granting the user the right to access or operate the system or part thereof. The system simply requires the input of a given sequence of fingerprint patterns, and so a full set of fingerprint data representative of all of a users fingerprint patterns is not required by the system, and neither is there a requirement to determine to which finger an input pattern relates. Rather all the system does is to identify whether or not an input pattern matches a pattern the system was expecting to be input.

Although fingerprints are widely recognised as being a good identification tool, there are a number of other biometric characteristics, which can be used to identify an individual, for example iris, voice or DNA pattern recognition techniques are known.

There is widespread concern about the ability of thieves to use information relating to the identity of an individual to gain, for example, unauthorised access to an individual's bank account or credit card account. Identity theft is also an increasing concern to governments and organisations where illegal use of another person's identity for criminal or illegal access purposes is a concern. The use of a biometric identification system in order to prevent such unauthorised access has been considered, for example by storing fingerprint information on a token, for example in the form of a smart card, or a biometric document like a passport or electronic file like an E-mail or text message, with an embedded biometric like a fingerprint template which is read by a biometric reader, the individual's fingerprint being compared with the stored information held on the token, card or passport or file prior to processing a transaction or gaining entry to a building or secure facility like a border crossing or an airport or a file. This approach has the risk that it may be possible to clone the smart card, passport or file and reprogram the fingerprint information held on the card or passport or document thereby allowing an unauthorised user to process transactions or gain unauthorised access.

Another concern has been the privacy of the individual's biometric data as an individual's biometric characteristic cannot be changed, like a password or PIN number can be changed. Where a government issues a Citizen ID Card containing the citizen's biometric data and this biometric data is also being used for identification for banking, computing or access to secure sites like offices and airports, the concern is that a hacker could steal the biometric data from the Citizen ID Card and use it to help gain unauthorised access to the citizen's bank account, computer or secure site. Freedom of Rights issues are also involved in the above scenario.

The present invention is intended to provide an identification system having an improved level of security. It also allows for novel User Role, Mode of Operation or Computer Application Switching capabilities.

In this respect a User Role could be a users membership of a group (for example, accounts, sales, administration, Project One Group, Project Two Group, etc. or the user's different role within an organisation, such as a Systems Administrator or an actual end user). A Mode of Operation could be an electronic switch which can be “open” or “closed” or a building or facility access security system with “low”, “medium”, “high” and “red alert” entry modes. Computer Application Switching could be between a Word Processing Program and a Spreadsheet, or between “Personal”, “Company” and “Company Confidential” documents.

According to the invention there is provided a secure control system for use in controlling the operation of a device having a plurality of functions, comprising inputting fingerprint pattern data relating to a fingerprint pattern of an individual using a fingerprint pattern reader, comparing the fingerprint pattern data with stored fingerprint pattern data to identify the individual whose fingerprint pattern data has been input and to identify to which of the individual's fingers the fingerprint pattern data relates, and controlling the operation of the device in response to the data representative of the identity of both of the individual and of the finger to perform a selected one of the plurality of functions.

One possible use of the invention is in controlling the mode of operation of a television. Each television channel is allocated to one of a user's fingers, and the television channel to be viewed may be selected by placing the appropriate of an individual's fingers onto a fingerprint reader. For example, channel one may be selected using one finger, channel two being selected using another finger. Where there are a large number of channels, then these may be selected by using appropriate fingers in sequence. As both the individual and the finger being used are identified, the television may be programmed to restrict access to some channels to a restricted group of authorised viewers, or alternatively some other settings of the television may be set to those preferred by that individual.

An alternative use for the invention is in logging on to a computer system with a range of access rights. As the system identifies both the user and which finger is being used, the system may be set up so that the use of one finger gives the individual a restricted level of access, the use of a different finger gives additional access rights, and the use of a third finger gives further access rights. Again, as the identity of the user is checked, access to certain areas can be restricted to smaller groups of authorised users. In this way the users can not only choose the access level required at a computer logon screen but can switch effortlessly between different levels of access rights or applications without the need to use logon screens and logon passwords.

In a further possible application, the input fingerprint data could be transmitted to a remote location where the identification process is performed and a device controlled in response to the fingerprint date being recognised. The fingerprint data would then be acting, in effect, as an electronic signature. Clearly, if the device at the remote location requires several fingerprints to be entered in a particular sequence, then the system security is further enhanced. The system further provides the ability of the user to effortlessly and securely switch the device from one mode of operation to another by inputing the finger or fingerprint sequence related to the new mode of operation.

The system could also be used with other devices incorporating switches, the function of the switch depending upon which individual is using the switch and which of the individual's fingers is being used. When the switch is active, the function of the switch can be securely changed by the the existing or a new user inputing a different finger or fingerprint sequence.

The system could alternatively be used in an access system having a duress warning system. In normal use, one of the user's fingers is used to gain access, for example to a computer system, the use of another of the user's fingers also gaining access, possibly at a restricted level, and also triggering an alarm or warning that the user has been forced to use the system under duress.

Another use for the system is where devices must be operated, either in areas of poor light or by the blind. In such cases, the use of a traditional key pad or control panel having buttons may be impractical, and instead the device may be operated by sensing which of an individual's fingers has been placed on a fingerprint reader, and associating a function with each finger. Alternatively number may be associated with each finger thereby permitting numbers to be entered. Clearly, number codes or large numbers may be input by placing the appropriate fingers onto the fingerprint reader in sequence.

The system may require two or more fingerprints to be input in sequence, the system determining whether the fingerprints have been input in a correct sequence and controlling operation of the device accordingly. In such an arrangement access rights are only granted when the fingerprints have been input in the correct sequence, thereby introducing an additional level of security.

According to another aspect of the invention there is provided a secure data entry system comprising assigning a data character to each of a plurality of an individual's fingers, inputting fingerprint pattern data relating to a fingerprint pattern of an individual using a fingerprint pattern reader, and comparing the fingerprint pattern data with stored fingerprint data to identify the individual whose fingerprint data has been input and to identify to which of the individual's fingers the fingerprint pattern data relates to determine which data character has been input.

Another use for the invention is for text entry on keyboards having only a small number of keys, for example on mobile telephone where names or text messages are to be entered for storage in an address book or for transmitting in the form of a text message, E-mail, or facsimile transmission. Each key may have several functions associated therewith, the function to be performed depending upon which of an individual's fingers are used to depress or operate the key. Although referred to herein as “keys”, it will be appreciated that each “key” may simply comprise part of a larger sensor area divided to define a plurality of “keys”.

It will be appreciated that in all of the arrangements mentioned hereinbefore, as the system must identify which of an operator's fingers is being used to operate the device, and as fingerprints provide an accurate technique for identifying individuals, the system automatically identifies the individual operating the device. A particularly attractive feature of the system is the ability of the system to allow users to switch effortlessly between user roles, modes of operation or computer applications simply by using different fingers or finger sequences.

The invention also relates to an identification method comprising entering first and second pieces of biometric information, comparing data representative of the first piece of biometric information with stored data held in a first data store, comparing data representative of the second piece of biometric information with stored data held in a second data store, and operating a device using the results of the two comparisons.

The invention will further be described, by way of example, with reference to the accompanying drawings, in which:

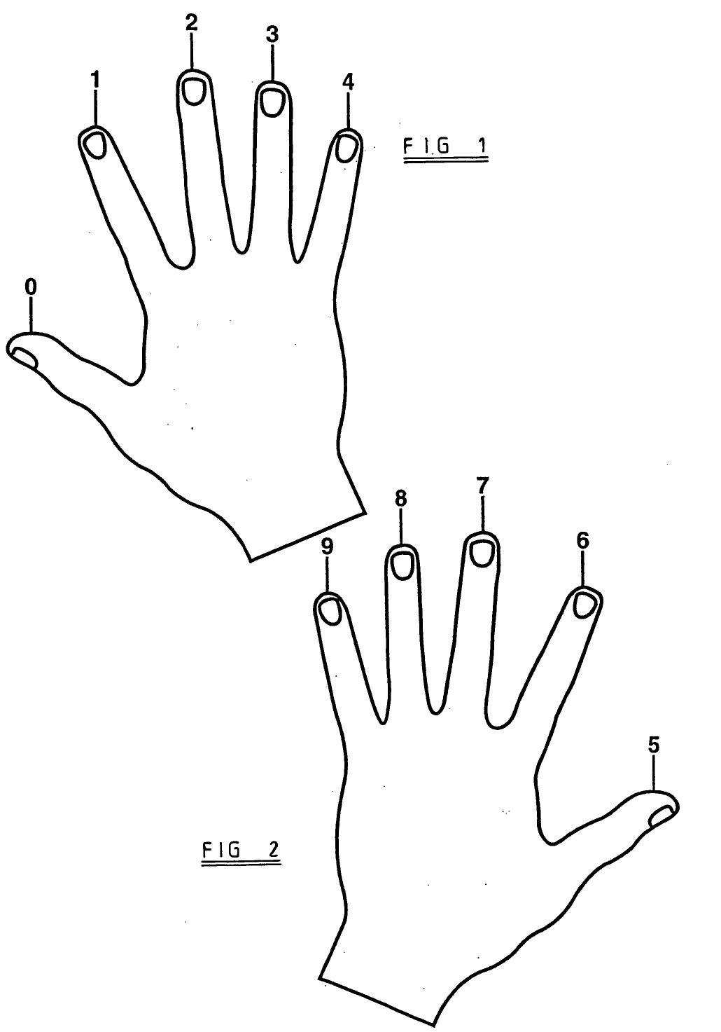

FIGS. 1 and 2 are views indicating possible codes associated with the fingers of a user's hands;

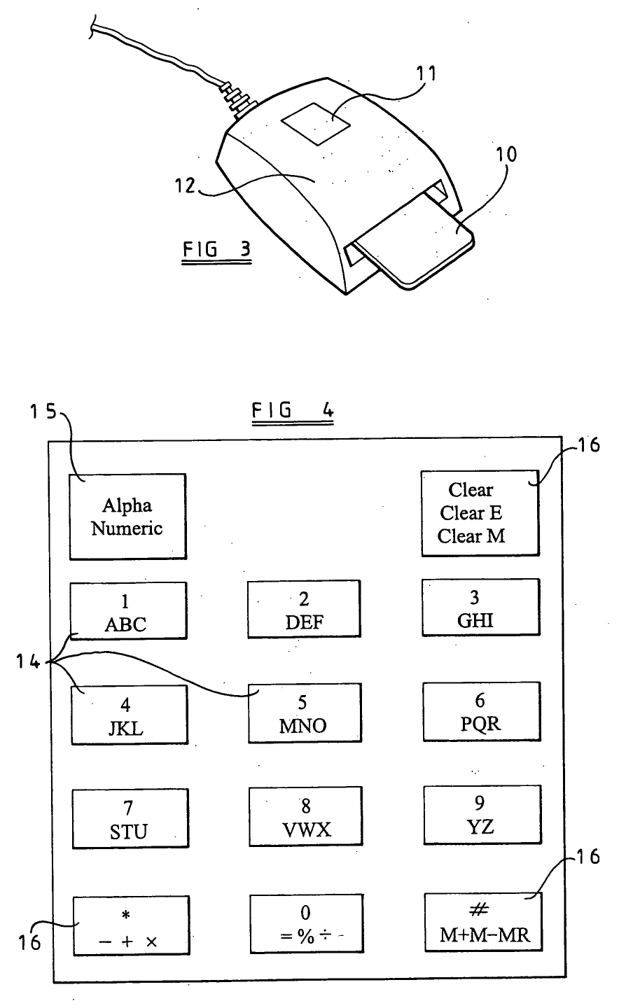

FIG. 3 is a view of a fingerprint reader suitable for use with the invention; and

FIG. 4 is a view of a key pad suitable for use with the invention.

As described hereinbefore, the invention is suitable for use in a wide range of applications. One possible application is in the inputting of numeric codes or numeric information or data. As illustrated in FIGS. 1 and 2, an individual's fingers have been allocated the digits 0 to 9. Data representative of the fingerprint patterns of all of the individual's fingers have been stored upon a smart card 10 (as illustrated in FIG. 3), or within a computer memory using a suitable fingerprint pattern reader and an appropriate recording device. The relationship between the stored fingerprint patterns and the allocation of the digits is also stored.

In use, when the individual wishes to input a numeric code or number, he simply places the appropriate ones of his fingers, in sequence, onto the sensor 11 of a fingerprint reader 12. In FIG. 3, the fingerprint reader 12 comprises a Biometrics Research Precise 100 sc ID, but it will be appreciated that other readers could be used. The reader 12 is used, in conjunction with the stored fingerprint pattern data, to identify the individual and to identify which of his fingers have been placed upon the sensor 11. Provided the reader or a device connected to the reader 12 is programmed in such a manner as to associate the correct digit with each finger, then the information input through the reader 12 can be used to denote a numeric code. It will be appreciated that the fingerprint recognition technique used may be one of a number of publicly available, known recognition techniques.

By way of example, where the code 284 is to be entered, then the fingerprints of right hand finger 2, left hand finger 4 and then right hand finger 4 should be placed upon the sensor 11 of the reader 12 in sequence. Although a specific code or number is mentioned herein, it will be appreciated that any number can be input or entered using this technique.

If desired, the identification process may be performed at a remote location and used to control a device at that location, the input fingerprint data acting, in effect, as an electronic signature. The invention may be suitable for use in electronic banking systems for example.

Where the entered code or number constitutes a security access code for controlling access to, for example, data held on computer as both the identity of the individual and the sequence in which the digits of the code or number are entered are recognised by the identification system, the system provides an identification system having an improved level of security over both systems that simply require the input of an identification number and over systems that use a single fingerprint to identify an individual. Although in the description hereinbefore a numeric code is input, it will be appreciated that this need not be the case, and that all that is required is that the fingerprints are input in the correct sequence. However, the allocation of numeric digits to the fingers may be advantageous particularly where the device requires the input of numeric information, in that subsequent operation of the device may be achieved without providing a numeric key pad. The invention may, therefore, be suitable for use in, for example, an automatic bank teller machine. The avoidance of the provision of a numeric key pad may be advantageous in that the cost of the device can be reduced, the risk of damage may be reduced and operation of the device in areas of poor lighting or by the visually impaired may be simplified as individual keys do not need to be depressed but rather a fingerprint input on a reader which may be of relative large dimensions.

The advantages mentioned above with regard to the avoidance of the provision of a key pad, use in areas of poor lighting or where the device is to be used by the visually impaired may be applicable in a wide range of other devices.

Although in the description hereinbefore, a number of fingerprints are input in a pre-determined sequence in order to gain control of a device, this need not be the case. Instead, control of a device may be achieved by inputting a single fingerprint, the device being controlled in accordance with which of the individuals fingerprints are input. By way of example, instead of typing a password to log onto a computer system with different modes of operation, say local computer, local area network and internet access, the identification system may be used. The system may be set up so that inputting of one fingerprint permits use of a local computer. Subsequent input of another fingerprint may allow use of a local area network and subsequent input of another fingerprint may permit internet access. In all three cases, the identity of the individual is determined and access denied if the individual is not recognised or not permitted the particular level of access. The system benefits by not requiring the user to remember and enter multiple passwords for each entry level and provides the user with the ability to effortlessly and securely switch between the entry levels without recourse to logon screens and passwords. It will be appreciated that such a technique is, in effect, a secure control technique, the operation performed being dependent upon both the identity of the individual and which finger or fingers have been used.

The system may alternatively be used to provide a warning in the event that a user is being forced to log onto a computer system or access other rights under duress. The system could operate in such a manner that placing one finger onto a fingerprint reader allows the user normal access, the use of another finger granting access rights, possibly at a reduced level, and also triggering an alarm or warning that the access rights have been obtained under duress. It is thought that a user, in a state of shock, is more likely to trigger the warning under such circumstances using the system of the invention than to trigger a warning using a conventional second password technique. Again, it will be appreciated that control of the system is dependent upon which fingerprint or fingerprints are input.

In an alternative application, the system could be used to control the operation of a television, controlling which channel is selected. Each television channel is allocated to a finger and the channel selected by inputting that finger's print. As the identity of the individual selecting the channel is determined, access to certain television channels may be restricted to only some of the unauthorised users of the television. Where the number of television channels exceeds ten, then higher numbers may be input by inputting fingerprints in sequence as described hereinbefore.

Another use for the invention will be described with reference to FIG. 4. FIG. 4 illustrates, diagrammatically, the key pad of a mobile telephone. The key pad has ten number entry keys or key pad areas. Each key comprises a fingerprint reader. Each key 14 has a numeric digit associated therewith. Additionally, some of the keys 14 have letters associated therewith. For example, the key 14 associated with the digit 1 also has the letters A, B and C associated therewith. The key pad further has a mode selection key 15 which is used to determine whether the key pad is to operate in text entry mode or in a number entry mode. The key pad also includes several other keys 16 which can be used to perform a range of functions, for example to permit a range of symbols to be entered or to permit the key pad to be operated in a calculator mode. The symbols which could be input include brackets, mathematical symbols and typographical symbols used where text is to be entered other than in the English language. As illustrated in FIG. 4, some of the symbols may also be associated with the key 14 associated with the digit O.

In use, when operating in the number entry mode, the key pad is used in the normal manner. In order to enter text, the mode selection key 15 is operated. Once in the text entry mode, each key 14 has several possible functions and which function is performed depends upon which finger is used to operate the key. For example, if it is desired to input a letter A, then the key 14 associated with digit 1 is operated using the index finger. To enter a letter B, rather than use the index finger, the middle finger is used.

After text entry has been completed, or if a number needs to be inserted, then the mode selection key 15 is operated to revert to number entry mode.

The key pad may be made up of a plurality of separate discrete fingerprint sensors, each sensor constituting one of the keys 14 as mentioned above. Alternatively, a single large fingerprint sensor may be used, the sensor being divided into a plurality of regions or zones, each zone forming one of the keys.

The use of the invention in this manner is advantageous in that text entry on a key pad having few keys can be achieved in a convenient manner. Further, as the individual operating device is identified, use by an unauthorised individual can be prevented.

Although described in relation to a mobile telephone, the invention is also applicable to other devices, for example electronic organisers.

In the arrangements described hereinbefore the stored fingerprint pattern data is held in a single location. Obviously there is the risk that if an unauthorised user gained access to the stored data he would be able to by-pass the enhanced security achieved using the invention. Rather than have the data stored in a single location, security may be further enhanced by dividing the data between two or more locations.

The following example relates to the use of the method of the invention in controlling the operation of an automated teller machine (ATM) or similar machine by an individual to determine whether or not the individual is authorised to access bank account information or process transactions, for example the withdrawal of money from the ATM.

In accordance with the method of the invention, a user of an ATM is issued with a smart card, that is to say a computer readable card carrying information relating to the individual's bank account, for example encoded information setting out the account number for the account. In addition, the card carries a storage device in the form of a chip capable of storing a relatively large amount of data. The storage device is programmed with user account data including biometric information representative of a characteristic of the individual, for example with fingerprint information relating to the fingerprint of the first finger of the individual's right hand.

A second piece of biometric information is stored upon, for example, a central computer database to which the ATM is connected. By way of example, the central computer database may be programmed with data representative of the fingerprint pattern of the user's second finger of his right hand.

In use, prior to being able to use the ATM to withdraw cash or perform another transaction, the user inserts his card into a card reader associated with the ATM. He then places, in sequence, the first and second fingers of his right hand on to a fingerprint pattern reader or scanner associated with the ATM. Fingerprint data representative of the two input fingerprints patterns are then compared with the stored fingerprint information held on the smart card and on the central computer database. A number of techniques are known for use in the automated comparison of input fingerprint pattern information with stored fingerprint data. Any of these techniques may be used, and so no description of how the comparison operation is performed is given here. The results of the two comparison operations can be used to determine firstly whether or not the user is the authorised user of the card, and also whether the user is authorised to perform transactions on the account to which the card relates.

The identification technique described hereinbefore has a number of advantages. Firstly, as it is comparing input data with stored data held in different locations the system is of improved security. There is also the advantage that only some of an individual's fingerprint information is permanently stored on the banks central database, rather than a full set of fingerprint information, thus the system may be viewed more favourably with those concerned about an individual's privacy than may otherwise by the case.

Other benefits of the system are that it could be used to enable a user to signal that he is being forced to operate the system under duress. By way of example, if a user places an incorrect finger on to the fingerprint reader, the result of the comparison operation may correctly identify the user, but the failure of the user to use his correct finger may be taken as an indication that he is being forced to use the system under duress. By way of example, the operator may place his finger, the fingerprint data of which is stored on the smart card on to the fingerprint reader at a time when he should have placed one of his fingers, the fingerprint data is held on the computer system, on to the fingerprint reader. Under such circumstances, the system may operate an alarm, and give the user limited use or no use of the system.

A further benefit of the system is that it may be easier to use by those who may struggle to use a conventional keypad, for example the visually impaired or those simply unused to using a keypad, as the system is less reliant upon the use of a keypad. As well as being easier to use, the security benefits outlined above will apply by virtue of the data being held in different locations.

There are a number of ways in which the simple method described hereinbefore may be enhanced. By way of example, if an increased number of fingerprints or other biometric characteristics are stored in either location, additional checks may be performed. The additional checks could include requiring the fingerprints to be read in a pre-determined order or sequence known to the user, as described hereinbefore, but bearing in mind that some of the fingerprint information is stored in the first store and some is stored in the second store. Alternatively, the ATM could be programmed in such a manner as to request the user to place one or more of his fingers on to the reader, the selection of which finger(s) to use being determined, for example, by a random number generator built into the program.

Another possibility is that the first and second pieces of biometric information may be parts of a single biometric characteristic. By way of example, an input fingerprint or iris pattern may be divided into two or more parts, one of which is compared with data representative of part of a biometric characteristic held on, for example, a smart card or biometric document or electronic file and another part of the input biometric being compared with data representative of part of a biometric characteristic stored, for example, on a computer system. It will be appreciated that, using this technique, no single data store contains data representative of even one complete biometric characteristic and no complete biometric characteristic is transmitted between the biometric reader and the data stores.

If this technique is used, then it will be appreciated that the comparison operation may require modification to allow for, for example, fingerprints being entered at different angles or with different pressure or with different time periods with which the finger is maintained in contact with the reader. In this way additional randomness is built into the security system which makes it more difficult for an unauthorised user to know how to present a duplicated fingerprint to the reader. Only the authorised user will know the sequence, angle of use, pressure or time to maintain the finger on the reader. The system will be programmed to identify an appropriate position at which to divide the input biometric characteristic into the two or more parts.

As described hereinbefore, by allocating a number or digit to each of a user's fingers, multi-digit numbers can be input without using a conventional keypad. Although the digits can be allocated to each of a user's fingers in sequence as described hereinbefore, this need not be the case. As a result, multi-digit numbers can be input with increased privacy and security as a passer-by would not be able to ascertain the input number without knowing the relationship between the user's fingers or with the angle of use, pressure or time the finger is maintained on the reader and the numbers represented thereby. Further, by storing fingerprint data in two locations, neither containing a full set of the data, an unauthorised user would not be able to input the full range of numbers even if he had previously accessed one of the data stores to modify the data stored therein and ascertain the above-mentioned relationship.

Although the description hereinbefore relates primarily to the operation of an ATM using fingerprint information to determine whether or not a user is the authorised user, the invention may be used in a wide range of other applications and equipment, and other biometric characteristics may be used instead of or in conjunction with fingerprint information. Further, although two specific examples of locations in which fingerprint data can be stored are given, the data may be stored in other locations.

One alternative application of the invention is in systems requiring input from two or more users, for example systems in which an operator enters information or requests a task to be undertaken, the operators entry or request subsequently being authorised or validated before being entered or completed. In such applications, the operator may have one biometric characteristic read and compared with a data stored in one location, for example on a smart card or a biometric document. He then enters information for verification by a second user, and this information is sent together with data representative of a second biometric characteristic to the second user. The second user likewise enters one biometric characteristic, which is compared, for example, with data stored on a smart card. Provided this comparison is accepted, he can then validate the request by entering a second fingerprint or other biometric characteristic, which is sent with the original request and the already attached biometric data to be actioned. Prior to being actioned, both of the attached biometric data are compared with centrally held data. This technique allows an electronic “signature” to be attached to a request in a secure manner, and may be suitable for use by, for example, financial institutions or, with appropriate modification, for controlling access to buildings, secure sites like border crossings and airports and to a wide area network or computer system allowing remote access thereto. Although this example uses two users—the requester and the validator; the spirit of the invention does not limit this to two users and more than one user of a group of users could be involved in creating and requesting approval and more than one user likewise involved in actioning the request.

1. A secure control system for use in controlling the operation of a device having a plurality of functions, comprising inputting fingerprint pattern data relating to a fingerprint pattern of an individual using a fingerprint pattern reader, comparing the fingerprint pattern data with stored fingerprint pattern data to identify the individual whose fingerprint pattern data has been input and to identify to which of the individual's fingers the fingerprint pattern data relates, and controlling the operation of the device in response to the data representative of the identity both of the individual and of the finger to perform a selected one of the plurality of functions.

2. A system as claimed in claim 1, wherein the device comprises a computer system and the data representative of the identity of the individual and of the finger are used in controlling access rights.

3. A system as claimed in claim 1, wherein the device comprises a switch mechanism and the data representative of the identity of the individual and the finger are used to determine how the switch mechanism operates and/or what is controlled by the switch mechanism.

4. A system as claimed in claim 1, wherein the device includes a plurality of sensor regions, each sensor region having a plurality of functions associated therewith, the function performed by the device depending upon the finger used to operate the device and which sensor region is used to input the fingerprint.

5. A system as claimed in claim 1, further comprising subsequently inputting second fingerprint pattern data relating to a second fingerprint pattern of the individual, comparing the second fingerprint pattern data with stored fingerprint pattern data to identify the individual whose second fingerprint pattern data has been input and to identify to which of the individual's fingers the second fingerprint pattern data relates, and controlling the operation of the device in response to the data representative of the identity both of the individual and of the finger to switch to a condition in which a second selected one of the plurality of functions can be performed.

6. A system as claimed in claim 5, wherein the selected one of the plurality of functions and the second selected one of the plurality of functions grant different access rights to the user.

7. A secure data entry system comprising assigning a data character to each of a plurality of an individual's fingers, inputting fingerprint pattern data relating to a fingerprint pattern of an individual using a fingerprint pattern reader, and comparing the fingerprint pattern data with stored fingerprint data to identify the individual whose fingerprint data has been input and to identify to which of the individual's fingers the fingerprint pattern data relates to determine which data character has been input.

8. A system as claimed in claim 7, wherein each data character comprises a numeric digit, and using the system to input a number.

9. A system as claimed in claim 8, wherein the step of comparing is repeated at least once using fresh fingerprint data to permit a multi-digit number or numeric sequence to be input.

10. An input device comprising an array of fingerprint sensor regions, the input device outputting signals dependent upon which of a user's finger is used and which sensor region is used at a given time.

11. An identification method comprising entering first and second pieces of biometric information, comparing data representative of the first piece of biometric information with stored data held in a first data store, comparing data representative of the second piece of biometric information with stored data held in a second data store, and operating a device using the results of the two comparisons.

12. A method according to claim 11, wherein one of the first and second data stores comprises a portable data store.

13. A method according to claim 11, wherein the first and second pieces of biometric information are entered simultaneously.

14. A method according to claim 11, wherein the first and second pieces of biometric information form parts of a single biometric characteristic.

15. A method according to claim 14, wherein the single biometric characteristic comprises one of a fingerprint pattern and an iris pattern.

16. A method according to claim 11, wherein the first and second pieces of biometric information are entered sequentially.
